(19) United States
(12) Patent Application Publication
(10) Pub. No.: US 2009/0196025 A1
(43) Pub. Date: Aug. 6, 2009

(54) CONE ASSEMBLY FOR ILLUMINATING COTTON CANDY WITH MULTI-COLORED, DIFFUSED LIGHT

(75) Inventors: DANIEL M. JOSEPH, LOS ANGELES, CA (US); GARY SCHNUCKLE, ALTADENA, CA (US)

Correspondence Address: DISNEY ENTERPRISES, INC.;c/o Marsh Fischmann & Breyfogle LLP, 8055 East Tufts Avenue, Suite 450, Denver, CO, 80237, US

(73) Assignee: DISNEY ENTERPRISES, INC., Burbank, CA (US)

(21) Appl. No.: 12/024,608

(22) Filed: Feb. 1, 2008

(51) Int. Cl. F21V 33/00

(52) U.S. Cl. 362/154

(57) ABSTRACT

An apparatus for illuminating cotton candy that includes a cone and a light source assembly. The cone has a sidewall that defines an exterior curved surface and is formed of white paper for diffusing light. The sidewall defines an interior chamber (e.g., the cone is a hollow cone) accessible via an opening at a base. The apparatus includes a light source assembly inserted into the interior chamber of the cone through the base. The light source assembly includes a light source, such as an RGB LED, that generates light that is transmitted into the cone interior chamber and further includes a switched power source connected to the light source. The cone sidewalls may be formed of paper and diffused light may be transmitted from substantially all of the exterior curved surface of the paper cone to cause the cotton candy to glow.

### BACKGROUND OF THE INVENTION

1. Field of the Invention

The present invention relates, in general, to novelty items that glow or flash light for use at night in amusement parks, at sporting events, and the like and, more particularly, to a light source and/or cone assembly for illuminating a food or edible product to increase point-of-purchase appeal of food-related items sold in evening hours or in darkened facilities.

2. Relevant Background

A significant source of revenue for operators of amusement or theme parks, theatres, and stadiums comes from the sale of novelty items or souvenirs and from the sale of food and drinks. For example, a family of four may spend more on souvenirs and food while at a sporting event than on the purchase of tickets, and such spending also occurs at theme parks as children not only want to go on the many rides but they also want to remember the experience with souvenirs and collectibles that they can take home.

Many purchasing decisions including purchases of novelty items and food are made at the point-of-purchase. A customer may smell popcorn or baked goods and decide upon that sensation to buy. Similarly, visual appeal at the point-of-purchase often causes customers to select one item over another or to make a purchase on an impulse. Additionally, many purchases of novelty items and food products are made after the customer, or their children, sees others with the product, e.g., wearing a particular hat or decorative button or eating an ice cream cone or other snack.

For many years, it has been common to make food products with interesting and exciting appearance to attract buyers. The food product may be made with bright colors to create attention or may be provided with a unique pattern or design. The food product may also be shaped to increase point-of-purchase appeal such as providing a snack in the shape of a popular character. Alternatively, the packaging may be designed specifically to increase interest, and the display and signage may be colorful and interesting.

At night, many novelty items include light to attract buyers, and these may include flashlights and glow sticks that come in many colors or display patterns. Some efforts have also been made to create edible novelty items and food products that are more attractive at night to increase sales. Typically, these lighted food products have been specially designed with a relatively large or complex handle that directs light up into an edible, hard candy such as a lollypop or the like. The handle typically will include a light source along with batteries to provide a point source up into the candy, and the handle is formed out of a hard, translucent plastic. The illuminated food product is typically discarded after the food is eaten as with other food items.

Illuminated food products have not been widely adopted in amusement parks and stadiums for a variety of reasons. Existing illumination techniques typically do not produce a visually appealing result as the point source of light results in only part of the snack being illuminated. Another issue with existing illumination techniques is that they require a unique handle that typically has to be fabricated offsite such as at a candy production facility. As a result, there are significant added shipping and storage issues associated with the illuminated product. While illumination may increase point-of-sale purchases, existing illumination techniques may significantly add to the price of a product, and it may be difficult to increase the cost of a food product to cover the added costs for illuminating the product. In any case, the profit margin may be lower for such products, which reduces the likelihood of their adoption in the food services industry.

Hence, there remains a need for improved methods for providing illuminated food products for use at amusement or theme parks, stadiums, and the like. Preferably, such illumination methods would be easy for vendors to implement and would be relatively inexpensive. Further, in some cases, it may be desirable for a vendor or workers at the point-of-purchase to be able to modify existing products to provide illumination as part of a sale or as part of creating a display.

### SUMMARY OF THE INVENTION

The present invention addresses the above problems by providing a cone assembly for use in illuminating cotton candy or similar food products. The cone assembly typically includes a lighting module fabricated for insertion into the open end of a cone such as for an interference fit with the inner walls of the cone. The cone may be a conventional cotton candy cone that is fabricated with white paper sidewalls, with the sidewalls being useful for diffusing light from the lighting module to transmit the light more uniformly through cotton candy attached to the paper cone (e.g., from all or more of the glowing surface rather than as a point source(s)). Cotton candy is desirable as the food product because it acts similarly to a plurality of light pipes or fiber optic filaments to transmit light as it is transmitted from the exterior, curved surface of the cone. The lighting module may include a red-green-blue (RGB) light emitting diode (LED) with a control chip/module (e.g., an embedded light sequencer chip or logic provided as part of the LED unit). The lighting module may further include a switch for selectively providing power from a power source in the lighting module (e.g., cell batteries or the like) that causes the control chip/module to automatically operate the high-brightness RGB LED to generate a repeating, sequential pattern typically including displaying three or more colors in some timed manner through the cone walls and cotton candy on the cone. In some embodiments, the lighting module may be added as a retrofit (e.g., to already prepared cotton candy on a cone or to a cone just prior to receiving cotton candy) and, in some cases, the lighting module is configured for use or a life after use in the cone assembly (e.g., as a souvenir or novelty item with a light feature such as part of a theme park character).

More particularly, one embodiment of the invention provides an apparatus for illuminating cotton candy that includes a cone and a light source assembly. The cone has a sidewall that defines an exterior curved surface for receiving the cotton candy, and the sidewall may be formed of white paper selected for diffusing light and extends from a base end to a tip end. The sidewall also defines an interior chamber (e.g., the cone is a hollow cone) accessible via an opening at the base end. The apparatus further includes a light source assembly inserted into the interior chamber of the cone through the base end opening. The light source assembly includes a light source that generates light that is transmitted into the interior chamber of the cone. The light source assembly also includes a power source connected to the light source and a switch for selectively providing power from the power source to the light source to generate the light.

The cone sidewalls may be formed of paper and as a result diffused light may be transmitted from substantially all of the exterior curved surface of the paper cone such that received portions of cotton candy are illuminated with the diffused light (e.g., at least about fifty percent of the exterior curved surface may transmit diffused light and often more than seventy-five percent (e.g., most if not all surface area above the position of the light source within the cone or diffuser). To facilitate in this desired amount of diffusion, the paper may be white paper and the cone may have a length of less than about 12 inches (e.g., such that the light source is within 12 inches of all interior surfaces of the cone). The light source may include an RGB LED and a control module for selectively operating the RGB LED to display differing colors in a sequential, repeating pattern (e.g., automatically with a light fading or sequencer chip provided in a single unit with the RGB LED that operates in response to receiving power from the power source such as when the switch is rotated to an “ON” position). The RGB LED may extend outward from the power source toward the tip end of the cone such that light transmitted from the light source is at least partially directed toward the tip end and substantially all of the interior chamber of the cone is struck by at least some light. The switch may be a rotatably mounted, circular base plate with a diameter greater than about an inner diameter of the opening in the cone base, and the power source may include a housing with a cylindrical sidewall with an outer diameter that is the same or less than about the inner diameter such that it abuts the interior chamber when the light source is inserted into the cone (further retention of the light source may be provided by providing an adhesive element such as double-sided tape on the sidewall of the power source housing).

According to another aspect of the invention, an illuminated food product is provided that includes a light diffuser made up of a curved sidewall. The sidewall typically is made of paper and defines an interior or inner chamber. A volume of food such as cotton candy is attached to the exterior surfaces of the sidewall. The illuminated food product further includes a lighting module that has an RGB LED that generates colored light in at least one time sequence (e.g., in response to receiving electrical power or electricity from a power source that typically is operable via a switch that is accessible external to the inner chamber of the light diffuser). The generated light from the LED is transmitted as diffused light from the light diffuser into the volume of food. The LED may include a sequencer module that functions to generate a plurality of colors in a predefined sequence or the at least one timed sequence. The light diffuser may be a white paper cone (such as used for cotton candy cones). The curved sidewall of the diffuser may have an exterior surface with a predefined area and the food product may be configured such that the diffused light is transmitted from at least about fifty percent of the predefined area.

According to another aspect, a light source assembly is provided for use in illuminating cotton candy that is attached to cotton candy cone. The assembly includes an LED for generating light and a control module that is connected to the LED to operate the LED by selectively directing electricity to the LED to generate the light in a sequential pattern. The light source assembly further includes a power source electrically connected to the control module to provide the electricity used by the control module/LED. A switch is also included to allow a user to toggle the power source between an “ON” position in which the power source provides the electricity to the control module and an “OFF” position. The power source may include a housing upon which the LED and the control module are mounted, and the housing may have outer dimensions (such as the outer diameter of a cylindrical sidewall) that enable the housing to be inserted into the base of the cotton candy cone (e.g., less than about 1.5 inches or about the same or less as the inner diameter of the base of the cotton candy cone). The LED may be an RGB LED, and the control module may be provided within a single shell or housing with the RGB LED (e.g., the control module may be a chip or logic circuit or LED driver provided integrally with or embedded in the LED). The sequential pattern of light transmission may be repeated by the control module and may include generating at least red light, green light, and blue light (or combinations thereof) in predefined patterns. The switch may include a rotatable, circular base plate that is attached to the power source, and the base plate may have an outer diameter that is greater than an inner diameter of the cone base such that the switch base plate stays outside or external to the cone. The cotton candy cone may include a body formed of a thickness (e.g., less than about 1/32 inch), and body may include a curved surface that transits diffused light by diffusing the LED light that hits inner surface of the cone body, whereby the cotton candy attached to the cone is illuminated with more uniform and/or widely distributed light in the sequential pattern.

### BRIEF DESCRIPTION OF THE DRAWINGS

FIG. 1 is a side view of an illuminated food product of one embodiment of the invention illustrating use of a conical diffuser to transmit light from a light source assembly to, for example, cotton candy;

FIG. 2 illustrates a perspective view of the light source assembly of FIG. 1 illustrating exemplary structural details including a sealing element (e.g., double sided tape);

FIG. 3 is a perspective view of a conical diffuser such as may be used in the illuminated food product of FIG. 1 showing a frustoconical configuration such as a paper cone used for cotton candy;

FIG. 4 is an exploded side view of the illuminated food product of the embodiment shown in FIG. 1 showing representative, but not limiting, internal components of the light source assembly;

FIG. 5 is a front perspective view of a light source assembly embodiment that may be used in a food product assembly as shown in FIG. 1 that is configured to provide a light source assembly that has a duel purpose as it may be removed from the food product assembly as a standalone novelty item; and

FIG. 6 illustrates use of the light source assembly of FIG. 5 as a decorative novelty item (e.g., a pin).

### DETAILED DESCRIPTION OF THE PREFERRED EMBODIMENTS

Briefly, the present invention is directed to a cone assembly for use with food products such as cotton candy for creating a food product that can be effectively, simply, and inexpensively illuminated to glow with shifting color patterns. The cone assembly of some embodiments is fabricated at the point-of-sale with a simple modification or retrofitting of a standard cotton candy cone to include a light source assembly. The light source assembly is structured with dimensions and attachment features to be inserted into the open end or base of the cotton candy cone, which may already have cotton candy attached (e.g., pre-bagged type cotton candy) or have cotton candy attached after the insertion of the light source. The illuminated food products may be distributed at a theme park and other consumer product applications such as evening sporting events. Once the cotton candy or food portion is eaten, the consumer may use the cone as a multi-colored glow stick or, in some cases, remove the light source assembly from the base of the cone for use as an illuminated novelty item or souvenir (e.g., a button that can attach to magnetic base worn by the customer or to a lanyard to be worn as a medallion or the like).

The inventors recognized that a standard cotton candy cone formed of paper acts as a conical or frustoconical diffuser that diffuses light from a point source, such as a light emitting diode (LED), for transmission more uniformly from the outer curved surface of the cone or cone body or sidewall. Use of the existing cones is highly advantageous as it allows vendors to simply modify the same products sold by day for sale at night and, in some cases, illuminated food products are only assembled as they are ordered or “on demand” to avoid having to stock numerous products for potential sale. The illuminated food products described herein typically are capitalizing on the unique ability of “spun sugar” or common cotton candy to act as a plurality of light pipes or fiber optic filaments. By creating and providing the low cost light source assembly that is embedded or inserted into a typical funnel or cotton candy handle/cone, light is distributed through the cone or, more accurately, from the curved surface of the cone or cone body into the spun sugar and outward through or into the mound of candy. The transmission of light outward creates a surprisingly bright, glowing fluffy mass that a consumer can wave around and also eat, and tests have shown that the light is distributed throughout the mound (substantially uniform distribution) rather than only at certain points (e.g., the light assembly and diffusing cone act together to provide a relatively well distributed light rather than appearing as a simple point source(s)).

The light source assembly or lighting module is generally conical in its outer dimensions to fit easily into the cone base (e.g., has outer dimensions for being received within a conical inner chamber of the conical diffuser). The light source assembly may be fabricated with a single LED such as an RGB (i.e., red, green, blue) LED or LED with RGB chips. In other cases, other light sources such as an LED cluster of two or more colored LEDs may be used such as a 3-LED cluster with two or more colored LEDs (e.g., a 3-LED cluster with a red LED, a blue LED, and a green LED that may used to provide similar effects and may be considered an RGB LED or LED cluster). Such cluster arrangements may be used to provide differing placements of the various colored light sources and will result in differing packaging and costs. In other cases, the light source is not an LED or includes other types of lights sources. In some cases, an RGB LED is selected that includes a light control module (e.g., the electronics and logic necessary for providing control of the LED) to provide color morphing and sequencing when power is provided, and the power supply may be two button cell batteries or other batteries. For example, a low cost, high brightness RGB LED with an onboard, embedded light sequencer chip (or fading chip) may be provided in the light source assembly to sequence through transmission of red, green, and blue light. The light source assembly can thus be completed inexpensively by providing a switch connected to the power source to supply power to the light control module and LED. For example, the switch may be a twist on/off switch provided at or as the base of the light source assembly such that extends outward from the base of the cone upon insertion of the light source assembly. As will become clear from the following description, the illuminated food product and the cone assembly used to provide the illumination can be produced with a relatively simple construction that will be attractive to the food service industry as workers can readily assembly the products and the added cost will be very low while the produced illumination effect likely will increase sales.

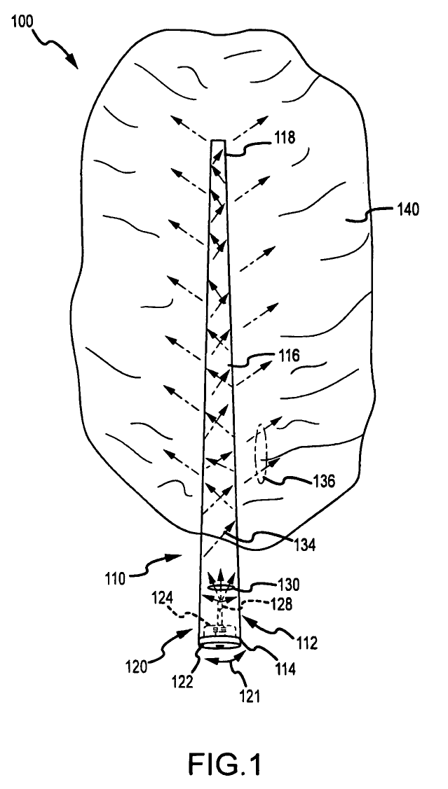

FIG. 1 illustrates an exemplary illuminated food product or illuminated snack assembly 100 of an embodiment of the invention. The illuminated food product 100 includes a cone assembly 110 that functions to provide a structural support and handle for an amount of food product 140 and to selectively (e.g., in response to operation of a switch) illuminate the food product 140 via a diffusing surface. The cone assembly 110 includes a cone or conical body 112 with a sidewall 116 that provides an outer curved surface of the cone 112 and defines an inner chamber (e.g., the cone body 112 is hollow). The curved surface or sidewall 116 extends from a base or larger diameter first end 114 to a tip or smaller diameter second end 118. The cone assembly 110 also includes a light source assembly or lighting module 120 that is inserted into the base 114 of the cone 112 to position its power source 124 and light source (e.g., a RGB LED) 128 within the inner chamber defined by the sidewall 116. A switch 122 extends outward from the base 114 or is at least accessible from the outside of the cone 112, and the lighting module 120 is operated in this embodiment by turning as shown at arrow 121 the ON/OFF switch or toggle switch 122, which provides power to the RGB LED 128 and/or its control chip that causes the LED to fade through or sequence through a particular pattern or patterns to transmit light 130 within the cone chamber. The LED-generated light 130 is then transmitted within the inner chamber of the cone body or sidewall 116 such that it contacts most of the inner surfaces of curved cone surface 116, and diffused light 136 is transmitted through the material of the sidewall/curved cone surface 116 to the food product 140.

In many cases, the food product 140 is chosen to be cotton candy because the fibers or strands of cotton candy have proven to effectively transmit the diffused light 136 from the curved surface or sidewall 116 of the cone 112, e.g., the candy behaves similar to light pipes, fiber optic filament, or the like to cause much of the body or mass of the candy 140 to glow. To practice the invention, a wide variety of cotton candy (as well as other similar food products) may be used as food product 140. Generally, cotton candy is intended to mean any of a number of light weight, sweet can made of threaded sugar that may or may not be tinted with food coloring and twirled onto the cone 112. Cotton candy is also known in some areas as candy floss, spun sugar, and fairy floss. Cotton candy is made from sugar and food coloring, e.g., white, pink, purple, yellow, orange, blue, and other colors. A common cotton candy machine may have a center part that includes a small bowl into which sugar is poured and food coloring is added. Heaters near the rim melt the sugar, and it is then spun out through tiny holes where it solidifies in the air (as fibers or strands that may carry light effectively) and is caught in a larger outer metal bowl. An operator of the machine may then twirl the cone 112 around the rim of the large catching bowl to pick up the candy and attach it to the sidewall or curved surface of the cone 116. The cotton candy 140 may have many air portions so that a serving is quite large such as about the size of a person's head, and when illuminated with the lighting module 120, the illuminated food product or assembly 100 provides a large glowing volume similar to a torch.

Particular embodiments of the lighting module 120 are described in more detail below, but, at this point, it is worth noting that the module 120 is adapted for insertion into a common and readily available cone 112, which may take the form of a conventional cotton candy cone. A special body does not have to be fabricated to house the module 120. Further, the module 120 is positioned within the cone 112 with the light source, e.g., an RGB LED or the like, 128 directed upward into the inner chamber of the cone 112 or generally toward the end or tip 118 of the cone 112. In this way, the light 130 generated from the LED or other light source 128 follows paths as shown at 134 that causes it to strike most if not all of the inner surface of the sidewall or curved surface 116 of the cone 112. In this way, the single LED 128 causes the entire surface 116 to glow or be illuminated, which provides a more desirable distribution of light 130 compared with a source that provides one or more point sources of light that are transmitted to an edible object.

The cone 112 may be considered a conical or frustoconical diffuser for the light 130 from source or LED 128 (with the term generally intended to include frustoconical as well as shapes similar to cones). The sidewall or curved surface 116 may be formed of plastic, e.g., frosted plastic, or other material that may be clear to translucent, but, more typically, it is formed of paper, which may be selected to be translucent so as to diffuse the light 130, 134 to produce a particular quality or level of diffused light 136 external to the sidewall or curved surface 116. In some preferred embodiments, the assembly 100 is produced as a modification or retrofit to existing candy cane products, and, in these embodiments, the cone 112 is a conventional and widely available cotton candy cone. Cotton candy cones are typically fabricated from a plain or patterned white paper that may be described as oak tag paper or as tough fiber white paper (e.g., southern kraft paper or the like) such as distributed by Gold Medal and other companies in the United States, and it may be triple wrapped at the ends (e.g., be one to three ply in the body 116). Through a number of experiments and testing, the inventors have determined that the paper walls provided by standard, plain white cotton candy cones (e.g., sidewall or curved surface 116 of cone 112) provide a desirable amount of diffusion to generate the diffused light from the source 128.

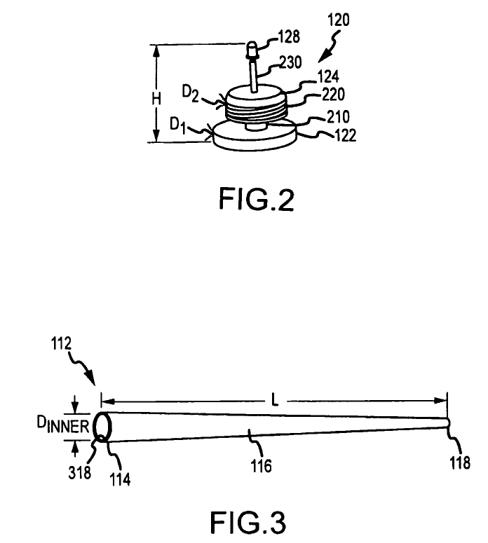

FIG. 2 illustrates in more detail a lighting module or light source assembly 120 that may be used in the illuminated food product 100 of FIG. 1. As discussed above, the lighting module 120 includes a base 122 that provides a rotatable or toggle switch via connection 210 to power source 124. The power source 124, in turn, provides electrical power to light source 128, which is shown to be an LED such as an RGB LED with a built-in light fading/sequencing chip (not shown). The light source 128 is extended outward from the power source 124 by support 230. The support 230 positions the light source 128 further into the inner chamber of the cone 112 and provides the bulb/LED 128 facing upwards or, when inserted as shown in FIG. 1, toward the distal tip or end 118. The height, H, may vary to practice the invention such as from about 0.5 to 6 inches, and more typically less than about 3 inches (e.g., about 2 to 3 inches) with the support 230 extending the light source 128 further into the cone 112 to place the light within or near the bottom of the candy 140 in assembly 100.

The light source assembly 120 is configured structurally to fit within the inner chamber of the cone 112, and, as such, the assembly 120 is also generally conical in shape with a base diameter, D₁, that is about the same as or, typically, somewhat larger than the diameter of the cone 112 at its base or end 114. In this way, as shown in FIG. 1, the switch is generally flush or slightly protruding from the outer surface of the sidewall or curved surface 116 at the base end 114, which allows the switch to be readily accessed to turn the source 128 on and off. The sizing of the base or switch 122 also provides a stop surface for contacting the sidewall 116 at base 114 to block the assembly 120 from being inserted too far within the inner chamber of the cone 112 (e.g., a person assembling the product 100 can push the assembly 120 into the cone 112 until the switch or base plate 122 abuts the end of the sidewall 116.

The power source 124 has an outer diameter, D₂, that is smaller than the outer diameter, D₁, of the switch 122. In other words, the outer profile of the light module 120 is conical in that the power source diameter, D₂, is smaller than the base 122 to define an outer surface that gradually gets smaller and reaches a tip or peak at the top of the light source 128. The power source 124 may have a diameter that is about the same as the inner diameter of the cone base 114 or slightly larger (such as the diameter of the outer diameter of the base 114) such that a press fit or interference fit is achieved when the light source assembly 120 is inserted into the base end 114 of the cone 112. In some embodiments, this interference fit is used to retain the assembly 120 in the cone assembly 110. In other cases, clips are mounted on the power source 124 or switch 122 that contact and pinch the sidewall 116 near the base 114 to attach the assembly 120 to the cone 112. As shown, a press fit is generally achieved and a more reliable mounting is provided with an adhesive element 220 that is provided on the power source 124 outer surface or sides that abut the inner wall of the cone 112. For example, double-sided tape may be used for the adhesive element 220, and a vendor of cotton candy would peel off the protective strip and then insert the assembly 120 into the cone 112 to cause the tape 220 to attach to the inner wall of the cone 112 near the base 114.

FIG. 3 illustrates a perspective view of a cone 112 that may be used in the assembly 100 of FIG. 1. Again, the cone 112 may be a conventional cotton candy cone (e.g., formed from white paper of desired translucency and/or thickness). The cone 112 has a curved surface or sidewall 116 extending from a base or first end 114 to a tip or second end 118. The base 114 is open (e.g., the cone 112 is hollow) with an inner chamber or opening defined by inner surface 318 of the sidewall 116 (which may be about 1/32-inches or less in thickness). The inner surface 318 receives the light module 120 in the cone assembly 110 shown in FIG. 1. The tip 118 may be closed in some cases or may be open as shown (e.g., the cone 112 may be frustoconical in shape). The cone 112 has a length, L, that may vary widely to practice the invention, but typically the length, L, is less than about 2 feet and, more typically, less than about 1 foot (e.g., 9 to 11 inches or the like). A length of less than about 1 foot has proven desirable in some tested embodiments as this provides a separation between the tip 118 and the light source 128 of less than 1 foot and more often less than about 10 inches, and use of an LED as source 128 is effective in transmitting light 134 this distance to illuminate the inner surface 318 near the tip 118, whereby light 136 is diffused by the sidewall 116 material and transmitted into candy 140 adjacent or proximate to the tip 118. The inner diameter, D_{INNER}, of the base 114 may also vary to practice the invention (with the outer diameter of the power source or another mating surface of the light module selected to match or be similar to this diameter in embodiments where mounting of the module 120 includes abutting contact with surface 318). For example, the cone diameter may range from about 0.5 to 4 inches with some embodiments having an inner diameter, D_{INNER}, in the range of 1 to 1.5 inches (e.g., about 1.375 inches is a common diameter form many conventional cotton candy cones).

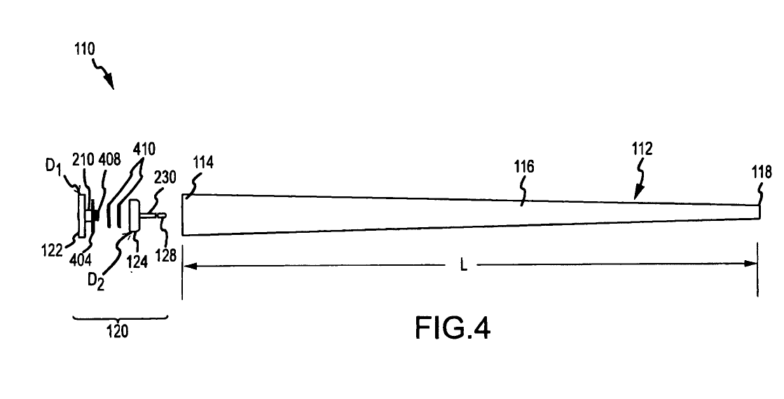

FIG. 4 illustrates an exploded view of the cone assembly 110 of FIG. 1. As shown, the lighting module 120 may include a power source 124 that includes a housing or battery compartment for a support plate 404 that is connected via extension 210 to switch 122. Batteries 410 may be forced into contact with the circuitry in 230 and LED 128 by spring 408. The batteries 410 may take different forms and may be button cells such as 3-volt button cells or the like. The lighting module 120 typically would be shipped in a state ready for installation as shown in FIG. 2 or the like, but FIG. 4 is useful for illustrating that it would be relatively easy to replace the batteries 410 so as to extend the life of the lighting module 120 (e.g., when the module 120 is configured for dual purposes such as for a novelty/souvenir item).

As discussed above, the light source 128 typically is an LED such as a RGB LED. Further, the light source 128 preferably includes the logic/circuitry necessary to sequence the RGB LED through its colors in one or more preset sequences. The sequences may be relatively simple such as transmitting red for a period of time than fade to or switch to green and then to blue or more complex sequencing may be provided to achieve a desired effect. In some embodiments, the switch is a multi-position switch and the RGB LED 128 has control logic that can run two or more sequences or light control routines based on the position of the switch (e.g., solid colors in certain positions, a first sequence at another position, a second sequence at another position, and the like). In other cases, the switch 122 also may be configured as a dimmer switch to control the amount of power presented by power source 124 to the LED 128 to control the brightness of the light 130 produced by the source 128. When a multi-color LED such as an RGB LED is used, the particular configuration may take a number of forms such as an RGB LED or the like with three LEDs encased in one shell or bulb (e.g., a red, a green, and a blue LED in one shell). In this case, a microchip or the like may be provided as a driver for the LED and be connected to the leads of each of the colored LEDs to selectively power them to create a particular effect, and in some embodiments, more than one LED may be provided current from the power source at a time to create more than three colors.

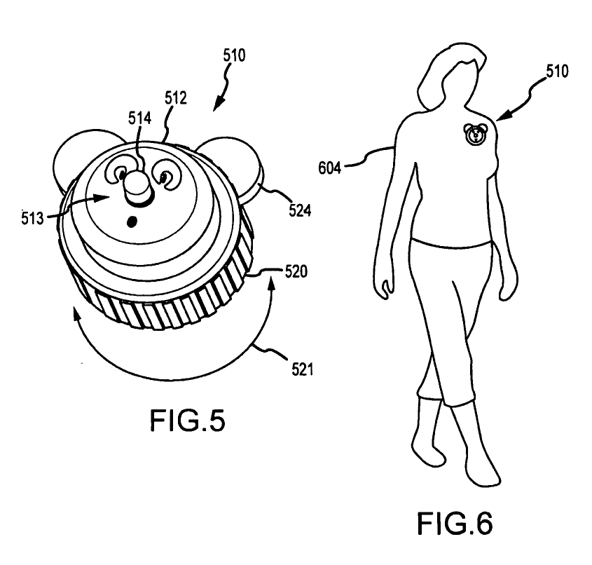

FIG. 5 illustrates another embodiment of a light source assembly 510 that may be used in an illuminated food product such as assembly 100 of FIG. 1 in place of light source assembly 120. Since the life cycle of the light source assembly 510 is greater than the food product or cotton candy, it may be useful to configure the assembly 510 to provide the functionality described for assembly 120 and to also be functional as a keepsake or novelty time by a customer. To this end, the light source assembly 510 includes a base plate or switch 520 that may be move or rotated as shown at 521 to activate a power source in housing or compartment 512. The power source such as cell batteries are connected to an LED 514 (e.g., an RGB LED with embedded sequencing controls/logic). The base plate or switch 520 includes additional decorative members 524 that add to the attractiveness or look and feel of the assembly 510 such that it may be desirable to keep and collect the assembly 510 as a souvenir (e.g., of a trip to theme park, sporting event, or the like). For example, the members 524 may be ears or other body parts of a character of a theme park. Further, the housing 512 may be configured or adapted to include other decorative elements 513 to further enhance the novelty/souvenir attributes of the assembly 510 (e.g., by providing facial features of a character, include text or images such as logos of a sports team, or the like). In this case, the LED may be provided as part of the image 513 such as the nose of a character. The assembly 510 also differs from assembly 120 in that the LED 514 is mounted proximate to the housing 512, and in some embodiments the LED 514 may even be flush or recessed in the housing 512 to protect it during shipping or for other design reasons. FIG. 6 illustrates a customer or other person 604 wearing the assembly 510 as a souvenir pin or button (e.g., the base or switch 520 may include another component (not shown) that facilitates its use as jewelry such as for receiving a necklace or lanyard or a metal piece for attachment to a magnetic pin/button).

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed. For example, in some embodiments, the diffuser is not conical and may take other forms such as a cylindrical tube formed of light diffusing materials such as paper (e.g., relatively thin white paper) or plastic/glass that may be frosted, etched, or otherwise treated for diffusion purposes. Typically, the cones are plain or a single color, but in other embodiments the cones may be printed with patterns so as to create lighted patterns in the cotton candy (e.g., to provide a template or gobo for projected light). The configurations illustrated in the figures generally showed the light source assemblies fit into the bottom or base of the cone, but the description provided herein and following claims are intended to cover other arrangements and placements of the light source. For example, the light source may extend upward from the base a greater distance to place one or more light sources further into the cone or even at the tip of the cone. In other cases, the light source may be provided as a separate unit from the control assembly and be positioned at one or more positions along the length of the cone including, in some cases, at the tip of the cone. In such positions, the light sources may be directed upward, transverse to the axis of the cone, and/or downward toward the base of the cone.

Additionally, the embodiments shown in the figures and discussed here have typically utilized a standard paper cone for diffusion of the light generated by the light source assembly. In some embodiments of the invention, though, the interior of the cone may be modified to include one or more reflective surfaces inside the paper cone (e.g., to create a partially reflective interior surface for the cone). The reflective surfaces would not cover all portions of the interior of the cone and would be used to selectively direct/concentrate light from the light source assembly onto particular portions of the cone. In this manner, a particular pattern or design may be generated by the light exiting the cone and entering the cotton candy. For example, the reflective surface (such as a foil or the like) may have a star pattern or a character shape cut out of it such that the reflected/concentrated light exits the cone with this pattern. In some cases, particular colors generated by the light source assembly are directed through particular portions of the reflective surface or to exit through particular apertures in the foil. In other cases, the foil may only be provided toward the bottom (or top of the cone) so as to direct the light out of the cone in a particular region of the cone such as in the upper half of the cone or upper third of the cone (e.g., adjacent the location of the candy or a portion of the candy). In addition to use of a foil to control transmission of light out of the cone in select areas, filters may be used to achieve one or more desired effects such by blocking light from exiting portions of the cone, by reducing the amount of light exiting the cone walls, and/or by blocking or filtering select colors from exiting certain portions or by changing the generated color to a different color in portions of the wall.

We claim:

1. An apparatus for illuminating cotton candy, comprising:
a cone with a sidewall defining an exterior curved surface for receiving the cotton candy extending from a base end to a tip end, the sidewall defining an interior chamber accessible through an opening at the base end; and
a light source assembly inserted into the interior chamber of the cone via the base end opening, the light source assembly comprising a light source for generating light that is transmitted into the interior chamber of the cone, a power source connected to the light source, and a switch for selectively providing power from the power source to the light source to generate the light.

2. The apparatus of claim 1, wherein the cone sidewalls comprise paper and wherein diffused light is transmitted from substantially all of the exterior curved surface, whereby received portions of the cotton candy are illuminated with the diffused light.

3. The apparatus of claim 2, wherein the cone has a length of less than about 12 inches and the sidewall paper comprises white paper.

4. The apparatus of claim 1, wherein the light source comprises a red-green-blue (RGB) light emitting diode (LED) and a control module for selectively operating the RGB LED to display differing colors in a sequential, repeating pattern.

5. The apparatus of claim 4, wherein the RGB LED extends outward from the power source toward the tip end of the cone, whereby the light transmitted from the light source is at least partially directed toward the tip end to strike substantially all of the interior chamber of the cone.

6. The apparatus of claim 4, wherein the control module comprises a light sequencer chip provided in a single unit with the RGB LED that operates to provide the sequential, repeating pattern automatically upon receiving power from power source.

7. The apparatus of claim 1, wherein the switch comprises a rotatable, circular base plate with a diameter greater than about an inner diameter of the opening in the cone base and the power source comprises a housing for holding one or more batteries, the housing having a cylindrical sidewall with an outer diameter less than about the inner diameter, whereby the sidewall of the housing abuts the sidewall when the light source assembly is inserted into the interior chamber of the cone.

8. The apparatus of claim 7, wherein the light source assembly further comprises an adhesive element provided upon the sidewall of the housing to contact the sidewall, whereby the power source is attached to the cone.

9. An illuminated food product, comprising:
a light diffuser comprising a curved sidewall formed from paper and defining an inner chamber;
a volume of food attached to exterior surfaces of the sidewall; and
a lighting module comprising an RGB LED generating colored light in at least one timed sequence, the RGB LED positioned within the inner chamber, wherein the generated light from the RGB LED is transmitted as diffused light from the light diffuser into the volume of food.

10. The illuminated food product of claim 9, wherein the volume of food comprises cotton candy.

11. The illuminated food product of claim 9, wherein curved sidewall is configured as a cone extending from a base to a tip and wherein the lighting module is at least partially inserted into the inner chamber via an opening at the base of the cone.

12. The illuminated food product of claim 11, wherein the RGB LED comprises a sequencer module functioning to generate a plurality of colors in a predefined sequence.

13. The illuminated food product of claim 12, wherein the sequencer module generates the plurality of colors in the predefined sequence in response to receiving electrical power from a power source operable by a switch that is accessible external to the inner chamber of the light diffuser.

14. The illuminated food product of claim 9, wherein the curved sidewall has an exterior surface with a predefined area and wherein the diffused light is transmitted from at least about fifty percent of the predefined surface area.

15. A light source assembly for use in illuminating cotton candy attached to a conventional cotton candy cone, comprising:
an LED for generating light;
a control module connected to the LED to operate the LED by selectively directing electricity to the LED to generate the light in a sequential pattern;
a power source electrically connected to the control module to provide the electricity; and
a switch for toggling the power source between an on position in which the power source provides the electricity to the control module and an off position, wherein the power source comprises a housing upon which the LED and control module are mounted, the housing having outer dimensions to enabling insertion of the housing into a base of the cotton candy cone.

16. The assembly of claim 15, wherein the LED is an RGB LED and wherein the LED and the control module are positioned within a housing that is attached to the power source housing.

17. The assembly of claim 16, wherein the sequential pattern is repeated by the control module when the control module is powered by the power source and wherein the sequential pattern includes at least generating red light, green light, and blue light.

18. The assembly of claim 15, the outer dimension of the housing are selected such that the housing abuts inner surfaces of the cotton candy cone upon insertion of the light source assembly.

19. The assembly of claim 18, wherein the switch comprises a rotatable, circular base plate attached to the power source, the base plate having an outer diameter greater than an inner diameter of the base of the cone, whereby the base plate remains external to the cone.

20. The assembly of claim 15, wherein the cotton candy cone comprises a body formed of white paper and the body comprises a curved surface that transmits diffused light created from the LED generated light passing through the white paper of the cone body, whereby the cotton candy is illuminated according to the sequential pattern.
